(19) United States
(12) Patent Application Publication
(10) Pub. No.: US 2004/0221922 A1
(43) Pub. Date: Nov. 11, 2004

(54) Box slotting router bit

(76) Inventor: Brent K. Hyde, Ottawa (CA)

Correspondence Address: JOHN S. PRATT, ESQ, KILPATRICK STOCKTON, LLP, 1100 PEACHTREE STREET, ATLANTA, GA, 30309, US

(21) Appl. No.: 10/824,104

(22) Filed: Apr. 14, 2004

Related U.S. Application Data
(60) Provisional application No. 60/463,625, filed on Apr. 16, 2003.

(51) Int. Cl. B26D 3/00; B27C 5/00; B27C 5/10

(52) U.S. Cl. 144/136.95; 144/134.1

(57) ABSTRACT

Router bits or cutters and methods of using such bits and cutters that enables a slotting cutter to cut a groove having appropriate widths and depths around the entirety of an assembled frame or box so that portions of the panel (or top or bottom in the case of a box) tongue is received around the entire panel, including in the corners. The slotting cutters of this invention have diametric proportions that allow a ⅛″ to 3/16″ deep slot to be cut with a sufficiently small radius at corners to produce a continuous slot around the inside of a frame or box corner.

### RELATED APPLICATION DATA

This application claims priority to U.S. Provisional Patent Application Ser. No. 60/463,625 filed Apr. 16, 2003 entitled “Box Slotting Router Bit,” which is hereby incorporated in its entirety by this reference.

### BACKGROUND

In building projects that use frame and panel construction, a slot ⅛″ to 3/16″ deep is usually cut on the inside of the four sides of the frame, and the panel is trapped in these slots. In making a flat panel, like a cabinet door, one can cut a deeper slot. However, such deeper slots typically are not desirable when a raised panel is used, and relatively small or thin frames such as the walls of small boxes typically cannot accommodate a deep slot because the walls are too thin; a deeper slot would cut completely through the wall.

Conventional slotting cutters for use in electric routers are between 1½″ and 3″ in diameter. To cut a ⅛″ deep slot using one of the these cutters would require a pilot bearing between 1¼″ and 2¾″ in diameter. However, with this cutter and bearing geometry, a continuous slot cannot be cut with the frame members assembled because the relatively large diameter bearing will not permit the cutter to reach into and cut a slot at the corners of the frame or box. A smaller diameter bearing that will travel further into the corner would produce an unacceptably deep slot.

### SUMMARY

This invention is a router bit or cutter and method of using such bits and cutters that enables a slotting cutter to cut a groove having appropriate widths and depths around the entirety of an assembled frame or box so that portions of the panel (or top or bottom in the case of a box) tongue is received around the entire panel, including in the corners. The slotting cutters of this invention have diametric proportions that allow a ⅛″ to 3/16″ deep slot to be cut with a sufficiently small radius at corners to produce a continuous slot around the inside of a frame or box corner.

Although other diameters and widths are possible, most of the situations typically encountered can be accommodated by slotting cutters of this invention 11/16″ in diameter and either ⅛″ or ¼″ wide with a bearing that is either 7/16″ in diameter (to produce a slot ⅛″ deep) or 5/16″ in diameter (to produce a slot 3/16″ deep).

Practice of this invention is typically begun by setting the box slotting bit height so that at least ⅛″ of material remains below the bit to support the panel; i.e., frame width beyond the slot or groove is at least ⅛″. The dry assembled frame is clamped together without glue to prevent the pieces from separating during the cut. The box or frame is positioned on the router table around, but not in contact with, the bit. The router is then turned on and the box or frame is moved around the bit while maintaining contact between the frame or box and the cutter bearing to create a slot of the proper depth and length in all four walls.

Although use of ball bearing guide bearings mounted on the same shaft as the wing cutter will typically be the most desirable set-up, this invention can also be practiced using a cutter of appropriate diameter and a separate bearing or follower surface, provided that the bearing or follower surface provides an arcuate surface for contacting the work piece (inside face of the frame) that is of the appropriate diameter and position in accordance with the description provided herein. The 360° surface of the guide bearings is not required, but typically the arcuate surface will need to provide at least 90° of surface or arc.

The slot cutting method of this invention is both quick to set up and easy and safe to execute. The corners of the panels to be received in the groove produced by this apparatus and method need to be rounded off, to fit within the radiused slot at the corners. However, is very easy to do on a belt sander, and the size and shape of the radius does not need to be perfect because the panel corners will be buried within the slot.

### BRIEF DESCRIPTION OF THE DRAWINGS

FIG. 1 is an end view, in section, of a small frame member such as a drawer side taken along line 1-1 in FIG. 2.

FIGS. 2 and 3 illustrate top (or bottom) views of frame corners where the frame thickness is ⅜″; FIG. 2 illustrates a groove 3/16″ deep, and FIG. 3 illustrates a groove ⅛″ deep.

FIG. 4 illustrates the necessary relative diameters or radii of a cutter of this invention, where the cutter radius is R₂ and the bearing radius is R₁.

FIGS. 5-8 illustrate various slot options that can be formed using a box slotting router bits according to this invention, including slot depth and panel thickness.

FIG. 9 illustrates setting the bit projection beyond a router table or base by reference to the panel which will be received in the groove or grooves formed by the bit.

FIG. 10 is a perspective view of a clamped frame or box.

FIG. 11 illustrates positioning the frame over the bit.

FIG. 12 illustrates bringing the workpiece to the bit (clamp not shown).

FIG. 13 illustrates cutting into the first corner (clamp not shown).

FIG. 14 illustrates running along an adjacent wall (clamp not shown).

FIG. 15 illustrates use of a radius gauge to mark the needed radius on a panel corner.

### DETAILED DESCRIPTION

The following provides more detailed information about the apparatus and methods of this invention.

When building with solid wood it is hard to find any superior alternative to frame and panel construction for cabinet doors, drawer bottoms or box lid and bottom panels. A key part of such construction is cutting the slot around the inside of the frame or carcass to accommodate the panel. A table saw may be used, but will leave a gap to be filled at each corner when the box is assembled. With a router table, there is always the debate whether to invest time and effort in an elaborate set-up or try to get away with a few risky cuts judged by eye. With the box-slotting bit of this invention, you need only set the bit for groove inset, clamp the frame together and run the bit along the four inside faces. This ensures that all four slots are aligned and that there are no corner gaps to hide.

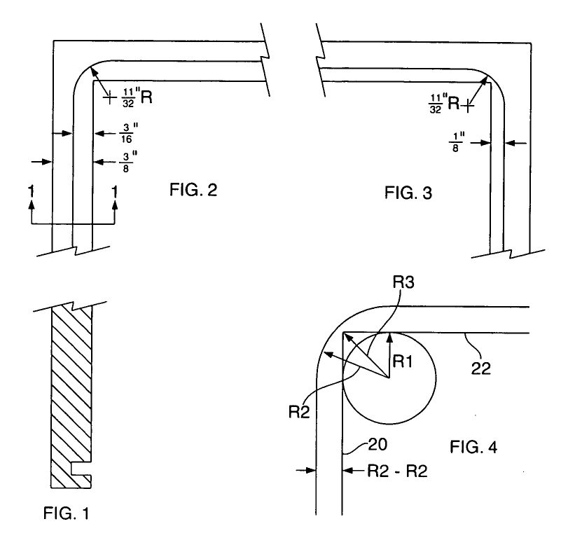

The dimensions and geometry of slots produced by the cutters of this invention can be appreciated by reference to FIGS. 1-4. FIG. 1 is an end view, in section, of a small frame member such as a drawer side taken along line 1-1 in FIG. 2. FIGS. 2 and 3 are top (or bottom) views of frame corners where the frame thickness is ⅜″. The slot cut in FIG. 2 is 3/16″ deep, and the slot cut in FIG. 3 is ⅛″ deep. In each case, the radius of the bottom of the slot at the frame corners is the radius of the cutter, 11/32″. As may be easily seen in FIGS. 2 and 3, in each instance, the bottom of the slot or groove is entirely within the frame, meaning that a radiused portion of the panel corner can still be within the frame.

FIG. 4 illustrates the necessary relative diameters or radii of a cutter of this invention, where the cutter radius is R₂ and the bearing radius is R₁. As FIG. 4 illustrates, R₂ must be large enough to reach the inside corner of the frame defined by frame edges 20 and 22. The cutter radius R₂ will just reach the corner, i.e., will be equal to R₃ when R₂ equals R₁×√2, which is approximately R₁×1.4142. Thus, for there to be a groove at the frame corner so that a portion of the panel edge can be within the frame at the corner R₂, must be larger than R₁×√2 (i.e., R₂>R₁×1.4142). As a practical matter, it is desirable for the depth of the groove at the box corner to be at least about one-third of the depth at the sides in order to insure that corners of the panels will be buried in the groove all the way around the panel. More detailed discussion of the practical limitations on the dimensions of cutters of this invention appear below.

In the examples set forth above, with the larger diameter bearing (7/16″ shown in FIG. 3), which produces a ⅛″ slot with a 11/32″ radius wing cutter, R₂ (11/32″=0.34375″) is greater than R₁ (7/32″=0.21875″) multiplied by 1.4142, which equals 0.30935″. The difference between R₂ and R₁×√2 is the depth of the slot or groove at the corner, in this example about 0.067″. This difference is somewhat larger when a deeper groove is formed by using the smaller diameter bearing, as is illustrated in FIG. 2.

The maximum slot depth that is practical with this cutter and technique is about one-fourth inch (¼″). If you work out the geometry where the surface at the bottom of the slot passes right through the inside corner where the box sides meet, the maximum cutter diameter is 1.7″ and the maximum bearing diameter is 1.2″. However, there is a problem with these limits. In using the techniques of this invention, it is desirable for the slot to cut well into the corner so that there is no gap between the box sides at the corner and the panel and to allow for some expansion space. Thus, the slot depth in the corner should be at least about one-third (⅓) the nominal slot depth (i.e., the depth of the slot remote from the corners. With an objective of at least one-third depth at the corners taken into account, the maximum diameter of the cutter is about 1.3″ and the maximum diameter of the bearing is 0.8″. However, there is another consideration. These cutter and bearing diameters would only work for making only slots nominally ¼″ deep. To make a shallower slot with the same cutter, the bearing diameter would need to be increased and, as a consequence, the depth of the slot at the corner would be reduced. In order to address this consideration, the dimensions can be worked out for a minimum slot depth of ⅛″. With a slot nominally ⅛″ deep, in order to maintain slot depth at the corners of at least one-third of that amount (i.e., at least 1/24″), the maximum diameter of the cutter would be 0.652″ and the diameter of the bearing would be 0.402″. Deeper slots can be then be made by reducing bearing diameter. These exact dimensions, 0.652″ and 0.402″, are not standard bearing or cutter diameters, but they are close to 17 mm (0.669″) and 10 mm (0.393″), with the result that it is practical to produce cutters with these cutter and bearing dimensions.

There is another consideration. Creation of a slot ¼″ deep with a 0.652″ diameter cutter would require a bearing 0.152″ in diameter. However, this is smaller than the smallest conventional woodworking router collet size and bit shank, ¼″ (0.250″), and therefore would be impractical. This is because the ¼″ diameter shank would interfere with the underside of the slot (i.e., the shank would prevent the cutter from reaching its full intended depth). Consequently, bearings need to be at least ¼″ (0.250) or greater in diameter. In order to determine the largest practical cutter diameter, assume the deepest practical slot to be one-fourth inch (¼″), and take into consideration the smallest bearing diameter possible (also ¼″). Therefore, the maximum diameter for a router cutter for this technique is approximately ¾″ (for multiple depths) or 1.3″ (for only ¼″ deep slots). Accordingly, the largest practical bearing diameter is ½″ for the ¾″ diameter cutter and 0.8″ for the 1.3″ cutter.

A desirable slot width most typically will be about ¼″ for relatively large projects. However, if this technique is utilized for substantially larger structures, such as blanket boxes, for example, then ⅜″ might be an appropriate maximum width.

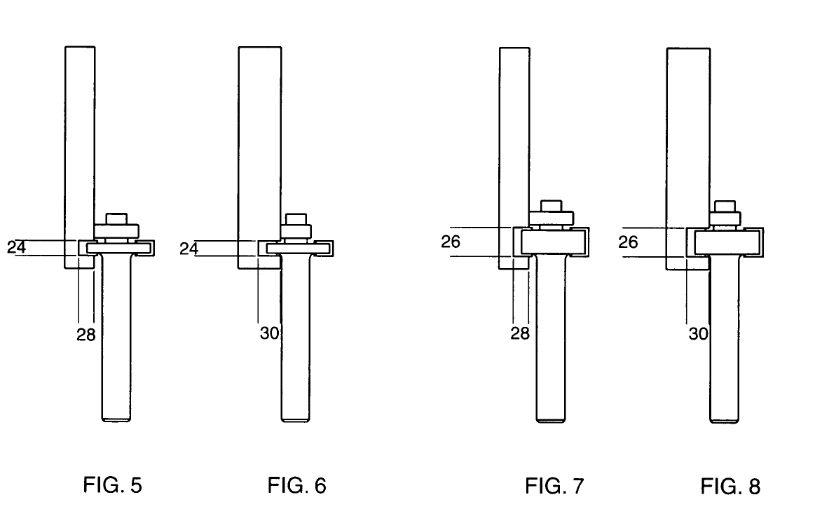

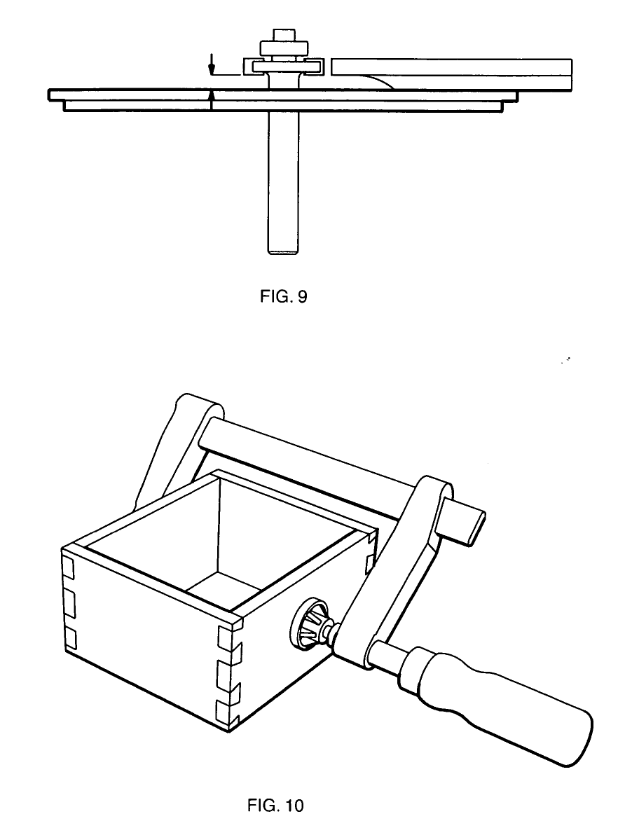

Bits can be made to accommodate panels of a desired thickness, such as ⅛″ thick panels and ¼″ thick panels. By providing a bit with two bearings a user can make use of different depths, such as ⅛″ or 3/16″ deep to best suit the thickness of the frame sides. The thickness of the exemplary panels 24 and 26 and the depth of the slots 28 and 30 are shown in FIGS. 5-8. FIGS. 5 and 6 illustrate bits that accommodate ⅛″ panels, while FIGS. 7 and 8 illustrate bits that accommodate ¼″ panels. FIGS. 5 and 7 illustrate bits having bearings for slots ⅛″ deep and FIGS. 6 and 8 illustrate bits having bearings for slots 3/16″ deep.

A description of a typical use of this invention follows. To create the slot in a frame, the bit height is set so that at least ⅛″ of material remains below the bit to support the panel, as shown in FIG. 9. To create the slot for a raised panel, the bit height is normally set so that the top of the cutter is flush with or proud of the panel thickness. Prior to cutting the slot, the frame should be clamped together without adhesive, as illustrated in FIG. 10. Clamping prevents the pieces from separating during the cut and provides a greater degree of safety.

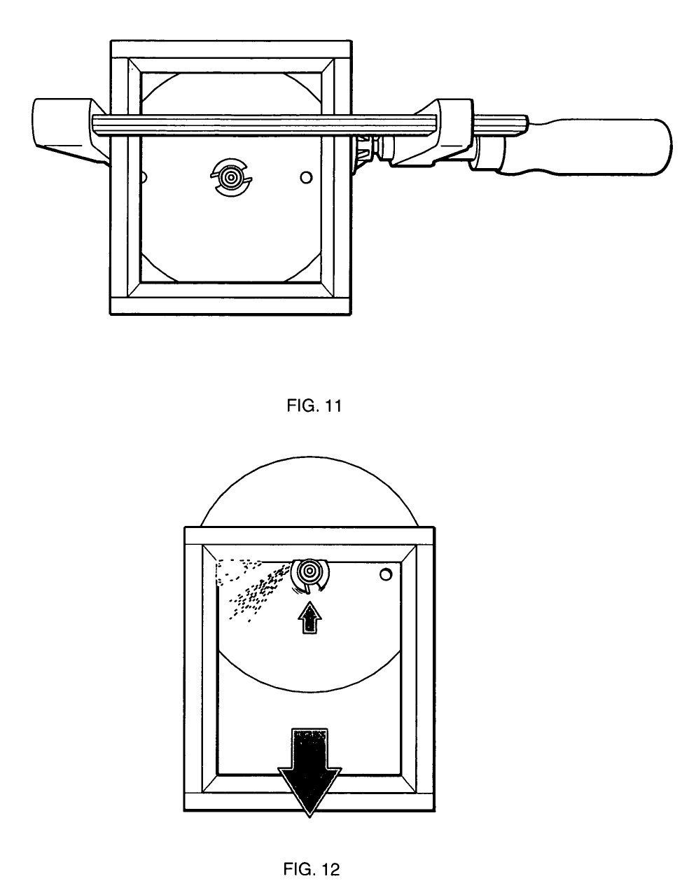

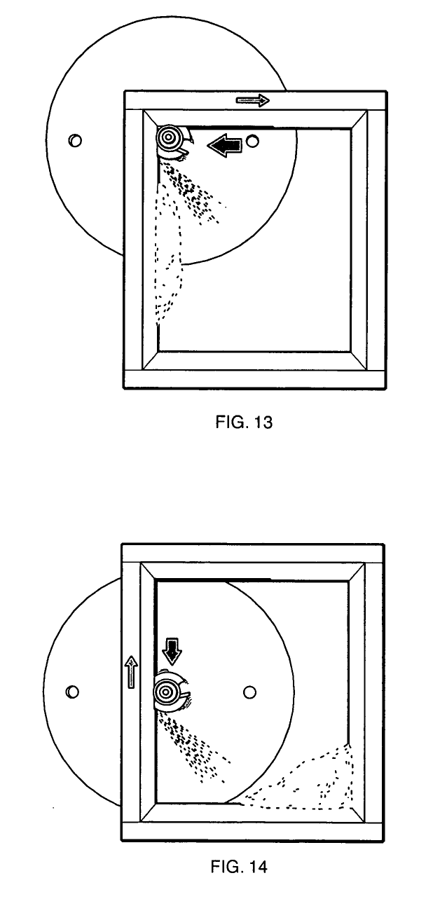

When cutting with these bits of this invention, care should be taken in ensuring slow and smooth control of the frame being cut. Cutting is commenced by positioning the frame over the bit, as shown in FIG. 11, and starting the router. The frame and bit are then moved relative to each other until the bit cuts into a wall of the frame and the bearing makes contact with the frame, as illustrated in FIG. 12. As the frame and bit slowly move relative to each other, the bearing should remain in contact with the frame. As the bit approaches the corner, relative movement is slowed to allow the bit to cut into the adjacent wall, as shown in FIG. 13.

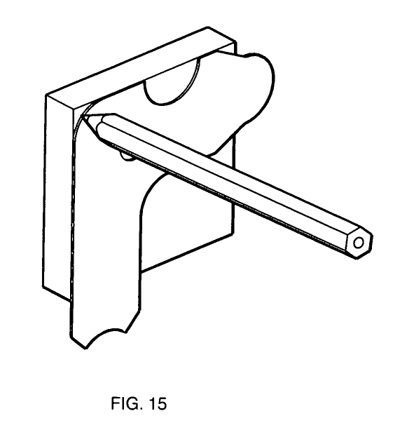

Once the cutter has completely entered the adjacent wall and the bearing is in contact with the wall, cutting may continue down the wall, as shown in FIG. 14. Cutting continues until a slot has been routed in all four walls. Because the frame is closed, there is no place for the chips to escape, so the chips and wood dust will accumulate.

Slots that are made using the bit and method of this invention will have round corners. In order for the panel to fit, the corners of the panel tongue will need to be rounded off as well. If the radius of the bit is 11/32″, then a 11/32″ radius should be applied to each corner of the panel. A radius gauge (illustrated in FIG. 15), a circle template or the router bit itself may be utilized to mark the radius. The corner may then be rounded over with a belt sander or in any other appropriate manner. The radius does not need to be perfect as the entire corner will be buried within the slot (but it cannot be smaller than 11/32″).

Variations of the structures illustrated in the drawings and the materials described above are within the scope and spirit of this invention and the following claims.

1. A router cutter for cutting panel-receiving grooves in frame or box members, comprising
a shaft for mounting in an electric router,
a cutter having a cutting radius mounted on the shaft, and
a guide bearing having a radius mounted on the shaft,
wherein the difference between the cutting radius and the bearing radius is greater than the bearing radius multiplied by the square root of 2.

2. The cutter of claim 1, wherein the guide bearing is approximately 5/16 inch in diameter.

3. The cutter of claim 1, wherein the guide bearing is approximately 7/16 inch in diameter.

4. The cutter of claim 2, wherein the cutting radius of the wing cutter is approximately 11/32″.

5. The cutter of claim 3, wherein the cutting radius of the wing cutter is approximately 11/32″.

6. The cutter of claim 1, wherein the cutting diameter of the wing cutter is approximately 0.669″.

7. The cutter of claim 4, wherein the cutter width is approximately ¼″.

8. The cutter of claim 5, wherein the cutter width is approximately ⅛″.

9. The cutter of claim 1 wherein the cutter diameter is approximately 17 mm and the bearing diameter is approximately 10 mm.

10. A method of cutting a groove to receive a panel in a frame having a plurality of members, comprising:
preparing the frame members by forming joint elements on the end of the frame members,
temporarily assembling the frame members into the frame having an inside face,
manipulating one of the temporarily assembled frame or a router to cut a continuous groove inside the frame using a router cutter while contacting the inside face of the frame with an arcuate bearing surface having an arcuate radius R with the arc centered on the cutter axis of rotation, wherein the cutting diameter of the router cutter is larger than the product of the radius R multiplied by the square root of 2.

11. A method of cutting a groove to receive a panel in a frame having a plurality of members, comprising:
preparing the frame members by forming joint elements on the end of the frame members,
temporarily assembling the frame members into the frame having an inside face,
manipulating one of the temporarily assembled frame or a router to cut a continuous groove inside the frame using a router cutter while contacting the inside face of the frame with a bearing follower having a radius R, wherein the cutting diameter of the router cutter is larger than the product of the radius R multiplied by the square root of 2.

12. A method of producing a frame and panel structure, comprising:
forming a rectangular panel having a tongue thickness T,
preparing frame members of appropriate length, and having end structures appropriate to join the frame members into a frame around the panel,
temporarily assembling the frame members into the frame having an inside face,
manipulating one of the temporarily assembled frame or a router to cut a continuous groove inside the frame using a router cutter while contacting the inside face of the frame with a bearing follower having a radius R, wherein the cutting diameter of the router cutter is larger than the product of the radius R multiplied by the square root of 2,
forming radii on the panel corners equal to or slightly larger than than the product of the radius R multiplied by the square root of 2 but small enough to insure that there will be panel tongue inside the groove at the frame corners, and
positioning the panel within the frame and permanently assemblying the frame.
